(19) United States
(12) Patent Application Publication
(10) Pub. No.: US 2012/0044596 A1
(43) Pub. Date: Feb. 23, 2012

(54) METHOD OF PRODUCING MAGNETIC RECORDING MEDIUM AND MAGNETIC RECORDING AND REPRODUCING APPARATUS

(75) Inventors: Shinichi Ishibashi, Tokyo (JP); Akira Yamane, Chiba (JP); Masato Fukushima, Chiba-shi (JP)

(73) Assignee: SHOWA DENKO K.K., Minato-ku, Tokyo (JP)

(21) Appl. No.: 13/255,450

(22) PCT Filed: Mar. 8, 2010
(86) PCT No.: PCT/JP2010/001611

§ 371 Date: Nov. 4, 2011

(30) Foreign Application Priority Data
Mar. 11, 2009 (JP) 2009-058116

(51) Int. Cl. G11B 5/84; B05D 3/06; B05D 3/00; B05D 5/00

(52) U.S. Cl. 360/110; 427/552; G9B/5.295

(57) ABSTRACT

There is provided a method of producing a magnetic recording medium having a magnetically separated magnetic recording pattern formed therein, without oxidizing or halogenating a surface of a magnetic layer, and also without contaminating the surface with dust and without complicating a production process,

the method of producing a magnetic recording medium characterized by including, in this order: a step of forming a magnetic layer (2) on top of a non-magnetic substrate (1); a step of forming a mask layer (3) for forming a magnetic recording pattern on top of the magnetic layer (2); and a step of irradiating an ion beam (10) onto regions in the magnetic layer (2) which are not covered by the mask layer (3), removing an upper layer portion of the magnetic layer (2) at that regions (7), and reforming magnetic properties of a lower layer portion (8), wherein two or more types of positive ions having different masses are used for the ion beam (10), and an ion gun for forming the ion beam has a positive electrode that forces out positive ions from an ion source towards a substrate side, and a negative electrode that accelerates the positive ions towards the substrate side.

### TECHNICAL FIELD

The present invention relates to a method of producing a magnetic recording medium to be used in a magnetic recording and reproducing apparatus, such as a hard disk device, and to a magnetic recording and reproducing apparatus.

Priority is claimed on Japanese Patent Application No. 2009-58116, filed Mar. 11, 2009, the content of which is incorporated herein by reference.

### BACKGROUND ART

In recent years, the application range of magnetic recording apparatuses, such as magnetic disk apparatuses, flexible disk apparatuses and magnetic tape apparatuses, has increased considerably, and the importance thereof has also increased. At the same time, an attempt is being made to highly increase the recording density of magnetic recording media used for these apparatuses. In particular, since the introduction of a magnetoresistive (MR) head and a partial response maximum likelihood (PRML) technology, an increase in the surface recording density has accelerated even more, and with the introduction of a giant magnetoresistive (GMR) head, a tunnel magnetoresistive (TMR) head or the like in recent years, the recording density has continued to increase at a rate as high as about 50% per year.

There are strong demands for even higher recording densities for these magnetic recording media in the future, and meeting these demands requires further improvements in the coercive force and signal to noise ratio (SNR) of the magnetic layer, and higher levels of resolution.

In addition, in recent years, concurrently with the improvements in linear recording density, efforts are also continuing into raising the surface recording density by increasing the track density. In the most recent magnetic recording apparatuses, the track density has reached 110 kTPI.

However, as the track density is increased, mutual interference tends to occur between the magnetically recorded information within adjacent tracks, and the resulting magnetized transition region in the boundary region between the tracks acts as a noise source, causing problems such as a deterioration in the SNR. This reduced SNR leads directly to a deterioration of the bit error rate, and is therefore an impediment to achieving increased recording densities.

In addition, in order to increase the surface recording density, it is necessary to reduce the size of each recording bit on the magnetic recording medium, and maximize the saturation magnetization and magnetic film thickness for each recording bit. However, as the recording bits are reduced in size, the minimum magnetization volume per bit is reduced, and a problem arises in that recording data may be erased due to magnetization reversal caused by heat fluctuation.

Further, because the distance between tracks reduces, the magnetic recording apparatus requires extremely high-precision track servo technology, and in addition to employing such technology, a method is usually employed where recording is executed over a comparatively wide range, and reproduction is then executed across a narrower range than that used during recording in order to eliminate effects from adjacent tracks as much as possible. Although this method enables inter-track effects to be suppressed to a minimum, achieving a satisfactory reproduction output level can be difficult, and therefore ensuring an adequate SNR is also difficult.

One method that is being investigated as a method capable of addressing the above problem of thermal fluctuation, ensuring a satisfactory SNR, or achieving a satisfactory output is a method in which the track density is increased by forming a pattern of protrusions and recesses that coincides with the track pattern on the surface of the recording medium, thereby physically separating the recording tracks from one another. Hereinafter, such a technique will be referred to as a discrete track method, and a magnetic recording medium produced by the method will be referred to as a discrete track medium.

In addition, an attempt has also been made to produce a so-called patterned media in which a data area within the same track is further divided.

One example of a known discrete track magnetic recording medium is a medium in which a magnetic recording medium is formed on a non-magnetic substrate which has a pattern of protrusions and recesses on the surface thereof, thereby forming magnetic recording tracks and servo signal patterns that are physically separated from each other (for example, see Patent Document 1).

In this magnetic recording medium, a ferromagnetic layer is formed on the surface of the substrate having a plurality of protrusions and recesses, with a soft magnetic layer disposed therebetween, and a protective film is then formed on the surface of the ferromagnetic layer. In this magnetic recording medium, the magnetic recording regions are formed on the protrusion regions, and are magnetically separated from the surrounding regions.

According to this magnetic recording medium, because the occurrence of magnetic domain walls within the soft magnetic layer can be inhibited, meaning thermal fluctuations are less likely to have an effect, and also there is no interference between adjacent signals, a high-density magnetic recording medium that suffers minimal noise can be formed.

Discrete track methods include methods in which a magnetic recording medium composed of a plurality of thin films is formed, and the tracks are then formed, and methods in which a pattern of protrusions and recesses is first formed, either directly on the substrate surface or within a thin layer provided for the purpose of track formation, and thin film formation (magnetic layer formation) of the magnetic recording medium is then conducted (for example, refer to Patent Document 2 and Patent Document 3).

In addition, a method of forming a region between the magnetic tracks of a discrete track medium by injecting ions of nitrogen, oxygen, or the like into a magnetic layer which is formed in advance, or by irradiating the magnetic layer with a laser beam so as to change the magnetic properties of that irradiated portion has been disclosed (refer to Patent Documents 4 to 6).

As described above, in producing a so-called discrete track medium or patterned medium which has a magnetically separated magnetic recording pattern, the methods of forming the magnetic recording pattern can be broadly classified into the following methods (1) and (2): (1) A method in which a portion of the magnetic layer is exposed to a reactive plasma or reactive ions using oxygen or halogens, thereby modifying the magnetic properties of the magnetic layer to form a magnetic recording pattern; and (2) A method in which a portion of the magnetic layer is processed through ion milling to form a magnetic recording pattern, and the processed portion is then filled with a non-magnetic material to smooth the surface.

Note that with regard to the structures of ion guns employed when conducting an ion milling process, those in which three electrodes are used in the plasma generation chamber have been disclosed (refer to Patent Document 7).

### CITATION LIST

### Patent Documents

[Patent Document 1] Japanese Unexamined Patent Application, First Publication No. 2004-164692

[Patent Document 2] Japanese Unexamined Patent Application, First Publication No. 2004-178793

[Patent Document 3] Japanese Unexamined Patent Application, First Publication No. 2004-178794

[Patent Document 4] Japanese Unexamined Patent Application, First Publication No. Hei 5-205257

[Patent Document 5] Japanese Unexamined Patent Application, First Publication No. 2006-209952

[Patent Document 6] Japanese Unexamined Patent Application, First Publication No. 2006-309841

[Patent Document 7] Japanese Unexamined Patent Application, First Publication No. 2005-1168655

### SUMMARY OF INVENTION

### Technical Problem

Incidentally, since there is no need to physically process the magnetic layer in the production method (1), it is advantageous in that the dust generation is minimal, which makes it easy to obtain a clean and smooth surface. However, the surface of the magnetic layer is either oxidized or halogenated, which is undesirable. Further, corrosion (migration of the magnetic particles of cobalt or the like included in the magnetic layer) of the magnetic recording media may occur, which originates from this oxidized or halogenated portion.

Moreover, in the production method (2), because the magnetic layer is physically processed, dust is generated to contaminate the surface of the magnetic recording media. In addition, the dust generated during the processing adheres to the surface, which may also cause reduction in the surface smoothness of the magnetic recording media. Furthermore, because it is necessary to fill the processed portion in the magnetic layer with a non-magnetic material, the production process also becomes complicated.

Under such circumstances, there has been a demand for a method of producing a magnetic recording medium having a magnetically separated magnetic recording pattern formed therein, without oxidizing or halogenating the surface of the magnetic layer, and also without contaminating the surface by dust and without complicating the production process. However, in the current situation, an effective and appropriate method has not yet been provided.

The present invention has been developed in light of the problems mentioned above, and has an object of providing a method of producing a magnetic recording medium having a magnetically separated magnetic recording pattern formed therein, without oxidizing or halogenating the surface of the magnetic layer, and also without contaminating the surface with dust and without complicating the production process.

### Solution to Problem

In order to achieve the above-mentioned object, the present invention provides the following aspects.

(1) A method of producing a magnetic recording medium having a magnetically separated magnetic recording pattern, the method characterized by including, in this order: a step of forming a magnetic layer on top of a non-magnetic substrate; a step of forming a mask layer for forming a magnetic recording pattern on top of the magnetic layer; and a step of irradiating an ion beam onto the regions of the magnetic layer which are not covered by the mask layer, removing an upper layer portion of the magnetic layer at that regions, and reforming the magnetic properties of a lower layer portion, wherein two or more types of positive ions having different masses are used for the ion beam, and an ion gun for forming the ion beam has a positive electrode that forces out positive ions from an ion source towards a substrate side, and a negative electrode that accelerates the positive ions towards the substrate side.

(2) The method of producing a magnetic recording medium according to the above aspect (1), characterized in that two or more types of the aforementioned positive ions having different masses are ions containing nitrogen and hydrogen or neon.

(3) The method of producing a magnetic recording medium according to the above aspect (1) or (2), characterized in that the aforementioned ion gun includes an earth electrode that stabilizes energy distribution of the positive ions from the ion source, and electrodes of the ion gun, i.e., the positive electrode, the negative electrode and the earth electrode are provided in this order from the ion source to the substrate side.

(4) The method of producing a magnetic recording medium according to any one of the above aspects (1) to (3), characterized in that a voltage applied to the aforementioned positive electrode is within a range from +500 V to +1,500 V, and a voltage applied to the aforementioned negative electrode is within a range from −2,000 V to −1,000 V.

(5) The method of producing a magnetic recording medium according to any one of the above aspects (1) to (4), characterized in that electrodes of the ion gun are mesh electrodes.

(6) A magnetic recording and reproducing apparatus characterized by including a magnetic recording medium obtained by the method described in any one of the above aspects (1) to (5), and a magnetic head for recording data in or reproducing data from the magnetic recording medium.

### Advantageous Effects of Invention

In the present invention, a step has been employed where an ion beam is irradiated onto the regions of the magnetic layer which are not covered by the mask layer so that the upper layer portion of the magnetic layer at that regions is removed, and also the magnetic properties of the lower layer portion is reformed. For this reason, since only the upper layer portion of the magnetic layer is processed by the ion beam, the amount of processing is minimal and the dust generation can be suppressed. As a result, a magnetic recording medium with a clean and smooth surface can be obtained.

In addition, the ion gun forming the ion beam has a positive electrode that forces out the positive ions from an ion source towards a substrate side, and a negative electrode that accelerates the positive ions towards the substrate side. In this manner, an ion beam suited for carrying out a removal of the upper layer portion and a reforming of the magnetic properties of the lower layer portion can be irradiated, and the removal of the upper layer portion and the reforming of the magnetic properties of the lower layer portion in the magnetic layer can be conducted with high precision.

In addition, in the present invention, since a mixture of nitrogen ions and hydrogen ions or a mixture of nitrogen ions and neon ions is used as the positive ions used for the ion beam, the removal of the upper layer portion and the reforming of the magnetic properties of the lower layer portion in the magnetic layer can be conducted at the same time and also with high efficiency. Further, since the ion beam does not include halogens, no halide is produced. As a result, corrosion which originates from the halides upon contact with air no longer occurs.

Moreover, in the present invention, the ion gun forming the ion beam includes an earth electrode that stabilizes energy distribution of the positive ions from the ion source, and electrodes of the ion gun, i.e., the positive electrode, the negative electrode and the earth electrode are provided in this order from the ion source towards the substrate side. As a result, irradiance level of the ion beam becomes uniform at the irradiated regions, so that the removal of the upper layer portion and the reforming of the magnetic properties of the lower layer portion in the magnetic layer can be conducted with high precision.

Furthermore, in the present invention, a voltage applied to the positive electrode is within a range from +500 V to +1,500 V, and a voltage applied to the negative electrode is within a range from −2,000 V to −1,000 V. As a result, an ion beam suited for carrying out a removal of the upper layer portion and a reforming of the magnetic properties of the lower layer portion in the magnetic layer can be irradiated with high precision.

In addition, in the present invention, since the electrodes of the ion gun are mesh electrodes, the irradiance level of the ion beam becomes uniform at the irradiated regions, so that the removal of the upper layer portion and the reforming of the magnetic properties of the lower layer portion in the magnetic layer can be conducted with high precision.

### BRIEF DESCRIPTION OF DRAWINGS

FIG. 1 is a cross sectional process diagram showing a method of producing a magnetic recording medium according to the present invention.

FIG. 2A is a cross sectional view showing an ion gun used in the production of the magnetic recording medium according to the present invention.

FIG. 2B is a cross sectional diagram showing an enlarged view of the ion gun used in the production of the magnetic recording medium according to the present invention.

FIG. 3 is a schematic configuration diagram showing an example of a magnetic recording and reproducing apparatus, to which the magnetic recording medium produced by the production method according to the present invention has been applied.

FIG. 4 is a graph showing the relationship between the etching depth and the coercive force (Hc), when the voltage applied to the positive electrode has been changed.

FIG. 5 is a graph showing the relationship between the etching depth and the saturation magnetization (Ms), when the voltage applied to the positive electrode has been changed.

FIG. 6 is a graph showing the relationship between the etching depth and the coercive force (Hc), when the voltage applied to the positive electrode has been changed.

FIG. 7 is a graph showing the relationship between the etching depth and the saturation magnetization (Ms), when the voltage applied to the positive electrode has been changed.

### DESCRIPTION OF EMBODIMENTS

More specific explanations for the method of producing a magnetic recording medium according to an embodiment of the present invention will be provided below with reference to the drawings.

It should be noted that the magnetic recording medium of the present embodiment has a structure in which a soft magnetic layer, an intermediate layer, a magnetic layer having a magnetic pattern formed therein, and a protective film are laminated on the surface of a non-magnetic substrate, and a lubricant film is further formed on the surface. However, those apart from the non-magnetic substrate and the magnetic layer may be provided when deemed appropriate.

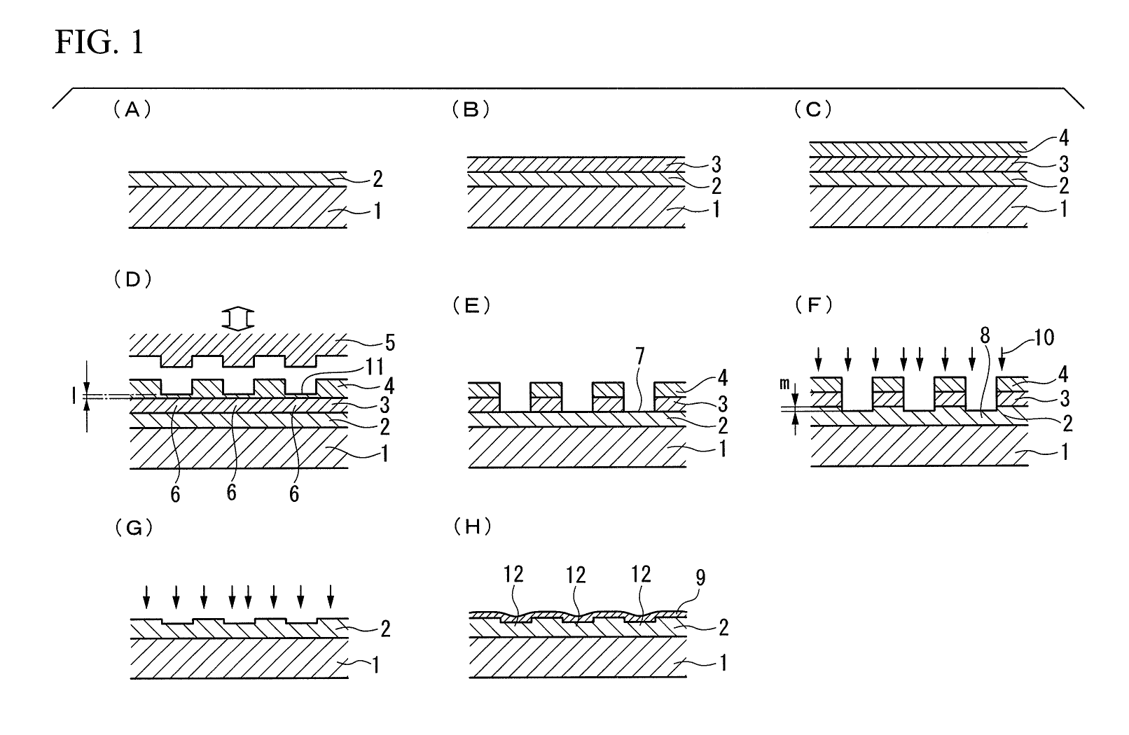

As shown in FIG. 1, the method of producing a magnetic recording medium according to the present embodiment includes, in this order: a step A of forming a magnetic layer 2 on top of a non-magnetic substrate 1; a step B of forming a mask layer 3 on top of the magnetic layer 2; a step C of forming a resist layer 4 on top of the mask layer 3; a step D of transferring the negative pattern of a magnetic recording pattern onto the resist layer 4 using a stamp 5; a step E of removing regions 6 corresponding to the negative pattern of the magnetic recording pattern in the mask layer 3; a step F of irradiating an ion beam onto the regions 7 of the magnetic layer 2 which are not covered by the mask layer 3 from the side surface of the resist layer 4, removing un upper layer portion of the magnetic layer at the regions 7, and reforming the magnetic properties of a lower layer portion 8; a step G of removing the resist layer 4 and the mask layer 3 through dry etching; and a step H of covering the surface of the magnetic layer 2 with a protective film 9. Each of these steps will be described below in great detail.

First, the magnetic layer 2 is formed on the non-magnetic substrate 1 (step A).

A sputtering method is usually employed as the method for forming the magnetic layer 2, although any adequate method may be employed.

As the non-magnetic substrate 1 used in the present embodiment, any of the following substrates can be used as long as it is a non-magnetic substrate, such as Al alloy substrates made of, for example, an Al—Mg alloy or the like, which are composed mainly of aluminum, or substrates made of ordinary soda glass, aluminosilicate-based glass, crystallized glass, silicon, titanium, ceramics, and various resins. Among these, it is preferable to use Al alloy substrates, glass substrates, such as crystallized glass, and silicon substrates.

In addition, the average surface roughness (Ra) of these substrates is preferably equal to or less than 1 nm, more preferably equal to or less than 0.5 nm, and most preferably equal to or less than 0.1 nm.

Further, although the magnetic layer 2 formed on the non-magnetic substrate 1 in the present embodiment may be either an in-plane magnetic layer or a perpendicular magnetic layer, a perpendicular magnetic layer is preferable in order to achieve a higher recording density. The magnetic layer 2 is preferably formed from an alloy containing Co as a main component.

For example, a laminated structure including a non-magnetic CrMo base layer and a CoCrPtTa ferromagnetic layer may be used as the magnetic layer 2 for an in-plane magnetic recording medium.

Examples of the magnetic layer 2 for a perpendicular magnetic recording medium include laminated structures constituted of a backing layer composed of a soft magnetic material such as a FeCo alloy (such as FeCoB, FeCoSiB, FeCoZr, FeCoZrB or FeCoZrBCu), an FeTa alloy (such as FeTaN or FeTaC) or a Co alloy (such as CoTaZr, CoZrNB or CoB), an orientation controlling film composed of Pt, Pd, NiCr, NiFeCr or the like, an optional intermediate film made of Ru or the like, and a magnetic recording layer composed of a 60Co—15Cr—15Pt alloy or a 70Co—5Cr—15Pt—10SiO₂ alloy.

With respect to the thickness range for the magnetic layer 2, the lower limit is preferably 3 nm and more preferably 5 nm, and the upper limit is preferably 20 nm, and more preferably 15 nm.

In addition, the magnetic layer 2 may be formed in accordance with the type of magnetic alloy used and the laminated structure, so as to achieve a satisfactory head input/output.

The thickness of the magnetic layer 2 must exceed a certain thickness in order to achieve an output of at least a predetermined level during reproduction, although various parameters that indicate the recording and reproduction properties tend to deteriorate as the output increases, and therefore the thickness must be set to an optimal value.

Then, the mask layer 3 is formed on top of the magnetic layer 2 (step B).

The mask layer 3 formed on top of the magnetic layer 2 is preferably formed from a material containing any one or more kinds of substances selected from the group consisting of C, Ta, W, Cr, CrTi, Ta nitride, W nitride, Si, SiO₂, Ta₂O₅, Re, Mo, Ti, V, Nb, Sn, Ga, Ge, As and Ni. Among these substances, it is preferable to use As, Ge, Sn or Ga, is more preferable to use Ni, Ti, V or Nb, and is most preferable to use Cr, C, Mo, Ta or W.

By using such a material, the shielding properties of the mask layer 3 relative to the milling ions can be improved, and the magnetic recording pattern-forming properties of the mask layer 3 can also be improved. Moreover, because these substances can be readily subjected to dry etching using a reactive gas, the amount of residues is reduced, enabling a reduction in contamination of the surface of the magnetic recording medium during dry etching (in step G).

After forming the mask layer 3, the resist layer 4 is formed on top of the mask layer 3 (step C), and a negative pattern of the magnetic recording pattern is transferred onto the resist layer 4 using a stamp 5 (step D).

At this time, following transfer of the negative pattern of the magnetic recording pattern onto the resist layer 4, the thickness 1 of the regions 11 within the resist layer 4 that correspond to the negative pattern is preferably within a range from 0 to 10 nm.

By ensuring that the thickness 1 of the regions 11 within the resist layer 4 satisfies this range, the step of etching the mask layer 3 (step E) can be performed without sagging of the edge portions of the mask layer 3, the shielding properties of the mask layer 3 relative to the milling ions can be improved, and the magnetic recording pattern formability provided by the mask layer 3 can also be improved.

In addition, material used for the resist layer 4 is preferably a radiation-curable material, and it is also preferred to irradiate the resist layer 4 with radiation, either at the same time as the step of transferring the pattern onto the resist layer 4 using the stamp 5, or following the pattern transfer step.

The term “radiation” used herein is a broad concept describing all manner of electromagnetic waves, including heat rays, visible radiation, ultraviolet rays, X-rays and gamma rays. In addition, examples of the radiation-curable material include a thermosetting resin in case of the heat ray and an ultraviolet curing resin in case of the ultraviolet ray.

By employing this type of production method, the shape of the stamp 5 can be transferred onto the resist layer 4 with high precision. As a result, the step of etching the mask layer 3 (step E) can be performed without sagging of the edge portions of the mask layer 3, the shielding properties of the mask layer 3 relative to the milling ions can be improved, and the magnetic recording pattern formability provided by the mask layer 3 can also be improved.

Especially when the stamp 5 is pressed against the resist layer 4 while the resist layer 4 is still in a state of high fluidity, and the resist layer 4 is cured by being irradiated with a radiation while being pressed, followed by detachment of the stamp 5 from the resist layer 4, the shape of the stamp 5 can be transferred to the resist layer 4 with high precision.

As a method for irradiating the resist layer 4 with radiation while the stamp 5 is still pressed against the resist layer 4, a method in which a radiation is irradiated from the opposite side of the stamp 5, i.e., the side of the non-magnetic substrate 1; a method in which a radiation-transmissive material is selected as a material for the stamp 5 and a radiation is irradiated from the side of the stamp 5; a method in which a radiation is irradiated from the side surfaces of the stamp 5; and a method in which a type of radiation such as heat that exhibits high conductivity relative to solids is irradiated by heat conduction through either the stamp material or the non-magnetic substrate 1, can be employed.

Further, it is preferred to employ an ultraviolet curable resin such as a novolak-based resin, an acrylate ester resin and an alicyclic epoxy resin as a material of the resist layer 4, and it is preferred to employ glass or resin which is highly transmissive to ultraviolet ray as a material of the stamp 5.

In addition, a stamp in which a fine track pattern is formed on a metal plate by employing a method such as electron beam lithography can be used as the stamp 5. As the material for the stamp, a material with the hardness and durability which can withstand the processes is required. For example, Ni or the like can be used. However, any materials may be employed as long as they achieve the object described above. In addition to the tracks for recording ordinary data, servo signal patterns, such as a burst pattern, a gray code pattern and a preamble pattern, can also be formed on the stamp 5.

Following transfer of the negative pattern of the magnetic recording pattern onto the resist layer 4, the regions 11 that correspond to the negative pattern within the resist layer 4 and the regions 6 that correspond to the negative pattern within the mask layer 3 are removed by etching (step E).

Thereafter, an ion beam 10 is irradiated from the side surface of the resist layer 4 onto the regions 7 of the magnetic layer 2 which are not covered by the mask layer 3, thereby removing un upper layer portion of the magnetic layer 2 at the regions 7, and also reforming the magnetic properties of the lower layer portion 8 (step F).

With respect to the range for the depth m that is removed from the upper layer portion of the magnetic layer 2, the lower limit is preferably 0.1 nm and more preferably 1 nm, and the upper limit is preferably 15 nm and more preferably 10 nm.

In those cases where the depth m to be removed is less than 0.1 nm, then the effects achieved by reforming the lower layer portion 8 of the magnetic layer 2 are not obtained, whereas if the depth to be removed exceeds 15 nm, then the surface smoothness of the magnetic recording medium tends to deteriorate, resulting in a deterioration in the magnetic head floating properties when producing a magnetic recording and reproducing apparatus.

The ion beam 10 is generated using nitrogen gas or a mixed gas composed of two or more types of positive ions having different masses. Specific examples of the mixed gas include a mixed gas composed of nitrogen and hydrogen, a mixed gas composed of nitrogen and neon, and a mixed gas composed of nitrogen, hydrogen and neon.

With respect to the range for the gas flow rate, although dependent on the size of the reaction vessel, in an ordinary sized reaction vessel, the lower limit is preferably 10 sccm, more preferably 13 sccm, and most preferably 15 sccm, and the upper limit is preferably 100 sccm, more preferably 50 sccm and most preferably 35 sccm.

When the flow rate is less than 10 sccm, the electric discharge becomes unstable, which is undesirable, whereas when the flow rate exceeds 100 sccm, the etching rate reduces, which is undesirable.

In addition, in those cases where a mixed gas composed of nitrogen and hydrogen is used, the proportion of nitrogen within the entire mixed gas is preferably not more than 63 percent, more preferably not more than 60 percent, and most preferably not more than 55 percent. The maximum effect was achieved at 50 percent.

When the proportion of nitrogen is less than 35 percent, the etching rate reduces, which is undesirable. Also, when the proportion of nitrogen exceeds 90 percent, reforming of the magnetic properties of the lower layer portion 8 becomes unsatisfactory, which is undesirable.

In addition, in those cases where a mixed gas composed of nitrogen and neon is used, the proportion of nitrogen within the entire mixed gas is preferably not more than 80 percent, more preferably not more than 70 percent, and most preferably not more than 60 percent. The maximum effect was achieved at 50 percent.

When the proportion of nitrogen is less than 20 percent, the etching rate reduces, which is undesirable. Also, when the proportion of nitrogen exceeds 80 percent, reforming of the magnetic properties of the lower layer portion 8 becomes unsatisfactory, which is undesirable.

In addition, in those cases where a mixed gas composed of nitrogen, hydrogen and neon is used, the proportion of nitrogen within the entire mixed gas is preferably not more than 90 percent, more preferably not more than 80 percent, and most preferably not more than 70 percent, and the proportion of hydrogen is preferably not more than 50 percent, more preferably not more than 40 percent, and most preferably not more than 30 percent.

When the proportion of nitrogen is less than 20 percent, the etching rate reduces, which is undesirable. Also, when the proportion of nitrogen exceeds 90 percent, reforming of the magnetic properties of the lower layer portion 8 becomes unsatisfactory, which is undesirable.

In addition, with regard to the range for the irradiance level of the ion beam per unit area, the lower limit is preferably 3.0×10¹⁵ atoms/cm², more preferably 4.0×10¹⁵ atoms/cm², and most preferably 4.8×10¹⁵ atoms/cm², and the upper limit is preferably 1.2×10¹⁶ atoms/cm², and more preferably 1.0×10¹⁶ atoms/cm², and most preferably 8.0×10¹⁵ atoms/cm².

When the irradiance level of the ion beam per unit area is less than 3.0×10¹⁵ atoms/cm², the etching rate reduces, which is undesirable. Also, when the irradiance level of the ion beam per unit area exceeds 1.2×10¹⁶ atoms/cm², the extent of damage given to the mask layer 3 increases, and the magnetic properties of the regions within the magnetic layer 2 that does not require reforming may also be deteriorated, which is undesirable.

In addition, with respect to the range for the etching rate, the lower limit is preferably 0.05 nm/second, more preferably 0.07 run/second, and most preferably 0.08 nm/second, and the upper limit is preferably 2.5 nm/second, more preferably 1.8 nm/second, and most preferably 1.0 nm/second.

When the etching rate is lower than 0.05 nm/second, the etching slows down and the productivity reduces. Also, when the etching rate exceeds 2.5 nm/second, the etching is conducted within a short period of time, which is difficult to control.

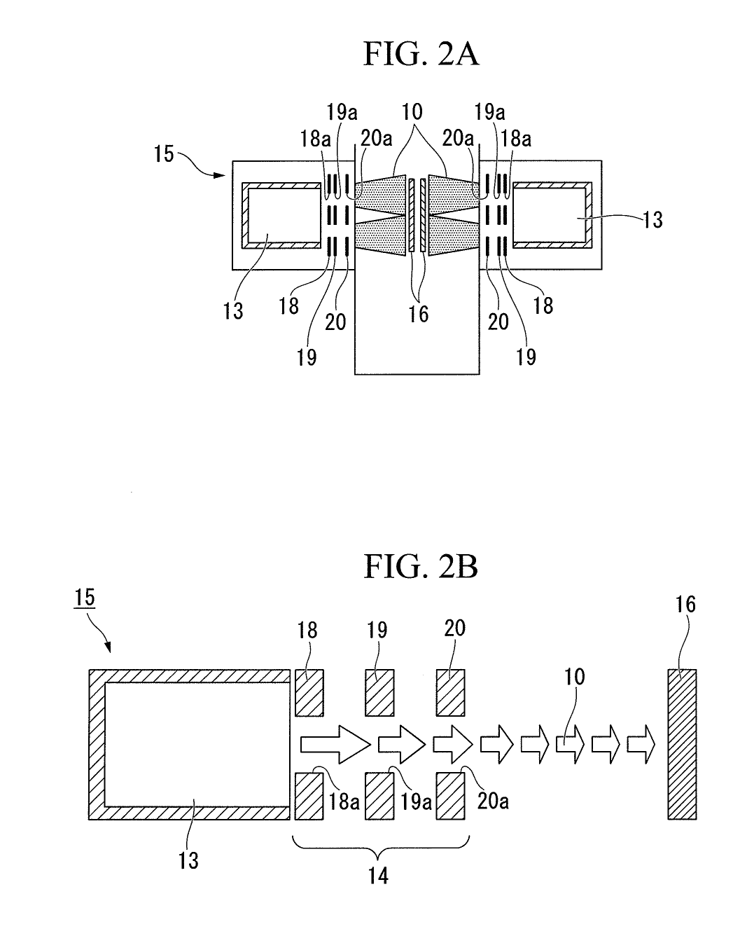

In addition, as shown in FIG. 2A and FIG. 2B, an ion gun 15 that forms the ion beam 10 is constituted of a plasma generation chamber 13 and electrodes 14 connected to a power source that is not illustrated in the drawings.

The electrodes 14 are constituted of a positive electrode 18, a negative electrode 19 and an earth electrode 20. The positive electrode 18, the negative electrode 19 and the earth electrode 20 are provided in this order from the plasma generation chamber 13 serving as the ion source to the side towards the non-magnetic substrate 1 serving as an irradiated substrate 16 subjected to irradiation of the ion beam 10 and where the magnetic layer 2, the mask layer 3 and the resist layer 4 are laminated.

All of the positive electrode 18, the negative electrode 19 and the earth electrode 20 are mesh electrodes in which mesh-like openings 18a, 19a and 20a are provided.

It should be noted that although the irradiated substrate 16 is illustrated with details omitted in FIG. 2A and FIG. 2B, in reality, it has a constitution shown in FIG. 1 (E) in which the magnetic layer 2, the mask layer 3 and the resist layer 4 are laminated on the non-magnetic substrate 1, and is arranged so that the resist layer 4 side faces the ion gun 15. Further, although a case is shown in FIG. 2A where two pieces of the irradiated substrates 16 are arranged, and the ion beam 10 is irradiated onto each of them by the ion guns 15 provided on the left and right sides, the substrates may be irradiated one by one. In addition, although a single opening is provided for each of the openings 18a, 19a and 20a in FIG. 2B, in reality, a plurality of mesh-like openings are provided.

The positive electrode 18 has a role of forcing out ions generated in the plasma generation chamber 13 serving as an ion source towards the irradiated substrate 16, and the voltage applied to the positive electrode 18 is set within a range from +500 V to +1,500 V.

In addition, the negative electrode 19 has a role of accelerating the ions which have been forced out by the positive electrode 18 towards the irradiated substrate 16, and the voltage applied to the negative electrode 19 is set within a range from −2,000 V to −1,000 V.

The earth electrode 20 is provided in order to stabilize the energy distribution, when irradiating ions which have been generated in the plasma generation chamber 13 serving as an ion source, forced out by the positive electrode 18 and accelerated by the negative electrode 19, towards the irradiated substrate 16 side.

By the ion gun 15 having a constitution as described above, as indicated by the arrow illustrated in FIG. 2B, the ion beam 10 is forced out from the opening 18a of the positive electrode 18, accelerated by passing through the opening 19a of the negative electrode 19, passed through the opening 20a of the earth electrode 20 so as to homogenize its energy distribution, and is eventually irradiated onto the irradiated substrate 16. Then, the upper layer portion of the magnetic layer 2 is removed while the magnetic properties of the lower layer portion 8 are reformed by the ion beam 10.

It should be noted that reforming of the magnetic properties of the magnetic layer 2 herein refers to the process of partially changing the coercive force, saturation magnetization, residual magnetization and the like of the magnetic layer 2 in order to pattern the magnetic layer 2, and these changes involve reducing the coercive force, reducing the saturation magnetization and reducing the residual magnetization.

Further, as for the reforming of the magnetic properties, it is preferable to employ a method of setting the saturation magnetization Ms of the regions 7 within the magnetic layer 2 that have been irradiated by the ion beam 10 to not more than 75%, more preferably not more than 50%, of the original (untreated) value, and setting the coercive force He to not more than 50%, more preferably not more than 20%, of the original value.

The magnetic layer 2 having a magnetically separated magnetic recording pattern can be formed by the steps described above. Further, due to the formation of a magnetically separated magnetic recording pattern, it is possible to eliminate the bleeding during magnetic recording to the magnetic recording medium and to provide a magnetic recording medium having a high surface recording density.

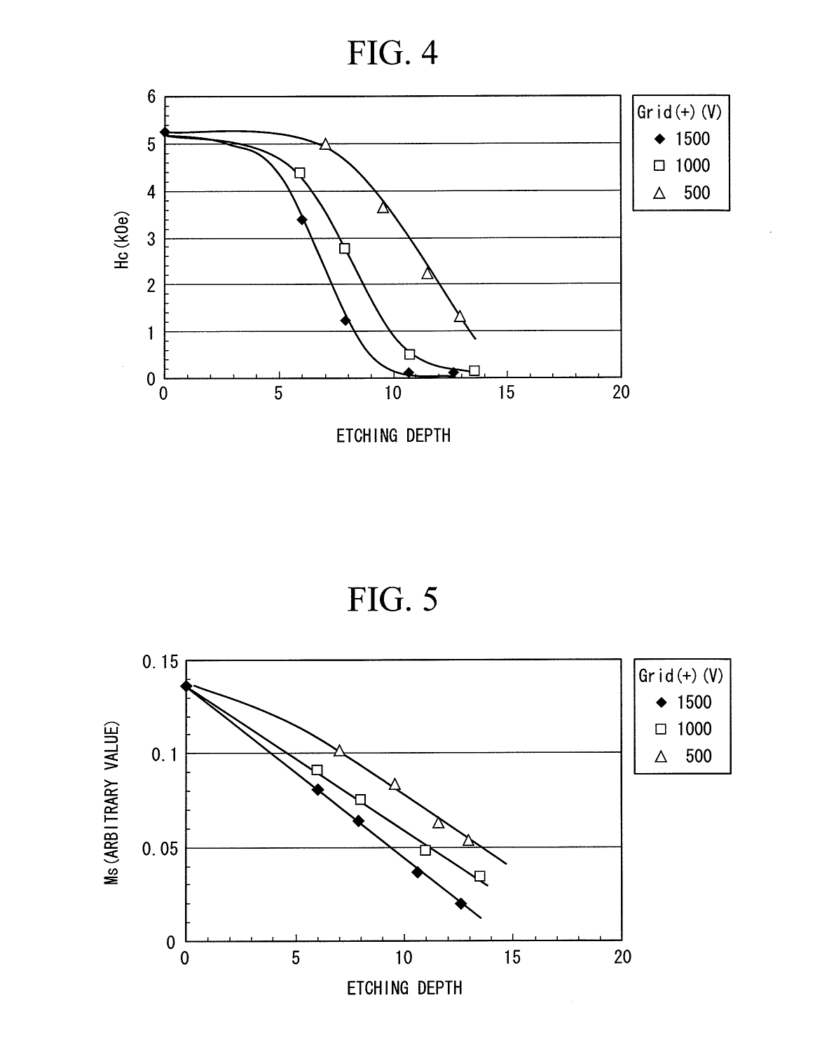

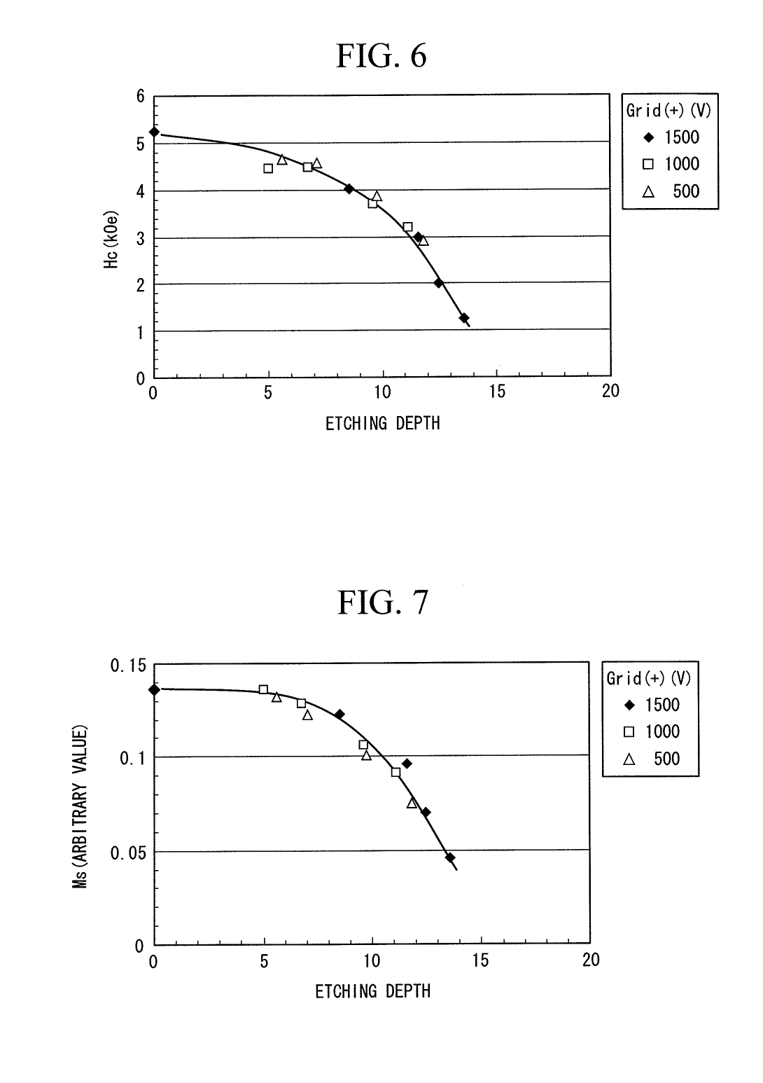

Note that FIG. 4 and FIG. 5 are graphs examining the amount of etching (etching depth) in the magnetic layer 2 and the changes in the coercive force (Hc) or saturation magnetization (Ms) of the magnetic layer 2, when the voltage applied to the positive electrode 18 was changed to +500 V, +1,000 V and +1,500 V while the voltage applied to the negative electrode 19 was fixed to −1,500 V, using the ion beam 10 generated with a mixed gas composed of nitrogen and hydrogen (volume ratio=1:1) with respect to a CoCrPt-based magnetic layer formed with a thickness of 16 nm. Further, FIG. 6 and FIG. 7 are graphs, for comparison, when the ion beam 10 generated with an argon gas instead of the mixed gas composed of nitrogen and hydrogen is used.

It should be noted that the substrates used in the experiments shown in FIG. 4 to FIG. 7 are those in which a 60 nm-thick soft magnetic layer composed of FeCoB, a 10-nm thick intermediate layer composed of Ru, and a 16-nm thick magnetic layer constituted of a 12-nm thick layer composed of a Co—Cr—Pt—SiO₂ alloy and a 4-nm thick CoCrPt layer laminated therein, are laminated on top of a glass substrate used in Examples to be described later, the mask layer and the resist layer are further formed as in Examples, and the negative pattern of the magnetic recording pattern has been transferred.

As shown in FIG. 4 and FIG. 5, when the voltage applied to the positive electrode 18 is +500 V, the etching depth in the magnetic layer 2 and changes in the coercive force (Hc) or saturation magnetization (Ms) of the magnetic layer 2 are expressed as a substantially linear relationship, and not many changes in the coercive force or saturation magnetization are observed.

On the other hand, when the voltage applied to the positive electrode 18 is +1,500 V, it is apparent that the coercive force (Hc) becomes substantially zero and the saturation magnetization (Ms) reduces to about a ⅓ level when the etching depth is set to 10 nm (the remaining magnetic layer is 5-nm thick).

Note that as shown in FIG. 6 and FIG. 7, in those cases where the ion beam 10 generated with an argon gas is used, reforming of the magnetic properties is hardly observed even when the voltage applied to the positive electrode 18 is changed, or even when the etching depth is changed.

In addition, although a case where the voltage applied to the negative electrode 19 has been fixed is shown in FIG. 4 and FIG. 5, similar observations can also be made when the voltage applied to the positive electrode 18 is fixed to +1,500 V while the voltage applied to the negative electrode 19 is changed to −1,000 V, −1,500 V and −2,000 V. In other words, although not many changes in the coercive force and saturation magnetization are observed in the case of −1,000 V, the coercive force and saturation magnetization sufficiently change in the case of −2,000 V.

It should be noted that in those cases where the voltage applied to the positive electrode 18 is increased to a voltage higher than +1,500 V or in those cases where the voltage applied to the negative electrode 19 is reduced to a voltage lower than −2,000 V, the depth to which ions are implanted becomes too deep, and, for example, ions eventually reach a soft magnetic backing layer in the case of the magnetic layer 2 for a perpendicular magnetic recording medium. As a result, the magnetic properties of the backing layer or the like deteriorate to generate spike noise in the magnetic recording medium, which is undesirable.

After forming the magnetic layer 2, the resist layer 4 and the mask layer 3 are removed through dry etching (step G), and after filling in the recesses with a non-magnetic material if necessary, the surface of the magnetic layer 2 is covered with a protective film 9 (step H).

It should be noted that although dry etching is employed for the removal of the resist layer 4 and the mask layer 3 in the present embodiment, a technique such as reactive ion etching, ion milling and wet etching may be used.

In addition, although the protective film 9 is generally formed by forming a thin film of Diamond Like Carbon by employing P-CVD or the like, the method is not particularly limited thereto.

The protective film 9 may be a carbonaceous layer composed of carbon (C), hydrogenated carbon (HxC), carbon nitride (CN), amorphous carbon, silicon carbide (SiC) or the like, or other materials that are usually employed as a protective film material, such as SiO₂, Zr₂O₃ and TiN.

Further, the protective film 9 may be constituted of two or more layers.

However, the thickness of the protective film 9 needs to be less than 10 nm. This is because if the thickness of the protective film 9 exceeds 10 nm, the distance between the head and the magnetic layer 2 becomes too great, and sufficient input/output signal intensity cannot be obtained.

In the present embodiment, it is preferable to form a lubricant layer on top of the protective film 9. Examples of the lubricant used for the lubricant layer include fluorine-based lubricants, hydrocarbon-based lubricants, and mixtures thereof. The lubricant layer is typically formed with a thickness of 1 to 4 nm.

Due to the steps described above, a magnetic recording medium in which a magnetically separated magnetic recording pattern is formed can be obtained.

Note that the magnetically separated magnetic recording pattern as described in the present embodiment refers to a state where the magnetic layer 2 is separated by regions 12 which have been reformed (either non-magnetized or weakly magnetized), when viewing the magnetic recording medium from the surface side. In other words, as long as the magnetic layer 2 appears separated by the reforming of magnetic properties when viewed from the surface side, then even if the bottom portion of the magnetic layer 2 is not separated, such a configuration is deemed to be included within the concept of a magnetically separated magnetic recording pattern.

In addition, with respect to the magnetic recording pattern referred to in the present embodiment, the reformed regions 12 need not be completely non-magnetic. In other words, as long as the magnetic head is capable of reading from or writing to the magnetic recording pattern portion, then even if the regions 12 exhibit a slight coercive force or saturation magnetization, such a configuration is deemed to be included within the concept of a magnetically separated magnetic recording pattern.

In addition, the magnetic recording pattern referred to in the present embodiment includes so-called patterned media in which each bit of the magnetic recording pattern is aligned with uniform regularity, media in which the magnetic recording pattern is arranged in the form of a track, as well as other patterns such as servo signal patterns.

Of these, application of the production method of the present invention to a so-called discrete magnetic recording medium in which the magnetically separated magnetic recording pattern is composed of magnetic recording tracks and a servo signal pattern is particularly desirable in terms of the simplicity of the production process.

In the present embodiment, a step has been employed where the ion beam 10 is irradiated onto the regions 7 within the magnetic layer 2 which are not covered by the mask layer 3 so that the upper layer portion of the regions 7 is removed, and also the magnetic properties of the lower layer portion 8 is reformed. For this reason, since only the upper layer portion of the magnetic layer 2 is processed by the ion beam 10, the amount of processing is minimal and the dust generation can be suppressed. As a result, a magnetic recording medium with a clean and smooth surface can be obtained.

In addition, since a mixture of nitrogen ions and hydrogen ions or neon ions is used for the ion beam 10, the removal of the upper layer portion and the reforming of the magnetic properties of the lower layer portion 8 in the magnetic layer 2 can be conducted at the same time and also with high efficiency. Further, since the ion beam 10 does not include halogens, no halide is produced. As a result, corrosion which originates from the halides upon contact with air no longer occurs.

In addition, the ion gun 15 forming the ion beam 10 has the earth electrode 20 that stabilizes energy distribution of the ions from the plasma generation chamber 13 serving as the ion source, and electrodes 14 of the ion gun 15, i.e., the positive electrode 18, the negative electrode 19 and the earth electrode 20 are provided in this order from the plasma generation chamber 13 towards the side of the irradiated substrate 16. As a result, the irradiance level of the ion beam 10 is homogenized at the irradiated regions, so that the removal of the upper layer portion and the reforming of the magnetic properties of the lower layer portion 8 in the magnetic layer 2 can be conducted with high precision.

Moreover, the voltage applied to the positive electrode 18 is within a range from +500 V to +1,500 V, and the voltage applied to the negative electrode 19 is within a range from −2,000 V to −1,000 V. As a result, the ion beam 10 suited for carrying out the removal of the upper layer portion and the reforming of the magnetic properties of the lower layer portion 8 in the magnetic layer 2 can be irradiated with high precision.

Furthermore, since all of the positive electrode 18, the negative electrode 19 and the earth electrode 20 are mesh electrodes, the irradiance level of the ion beam 10 is homogenized at the irradiated regions, so that the removal of the upper layer portion and the reforming of the magnetic properties of the lower layer portion 8 in the magnetic layer 2 can be conducted with high precision.

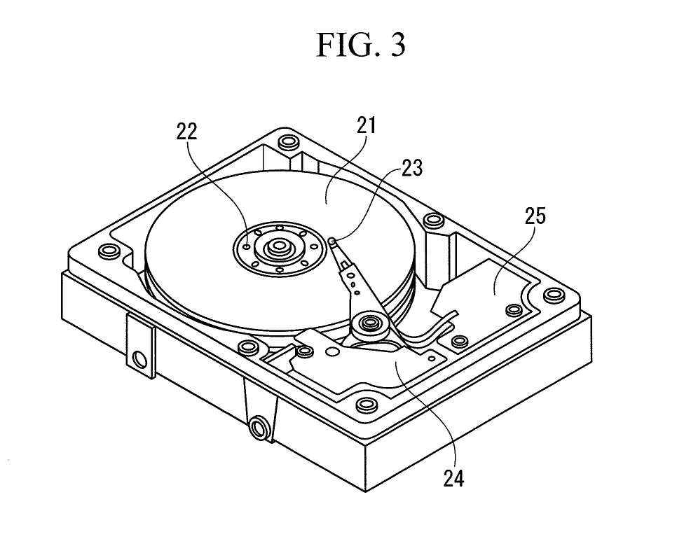

One example of a magnetic recording and reproducing apparatus that uses the magnetic recording medium described above is illustrated in FIG. 3.

The magnetic recording and reproducing apparatus shown in FIG. 3 includes a magnetic recording medium 21 obtained using the method described above, a medium drive unit 22 that drives the magnetic recording medium in the recording direction, a magnetic head 23 constituted of a recording unit and a reproduction unit, a head drive unit 24 that moves the magnetic head 23 relative to the magnetic recording medium 21, and a recording/reproducing signal system 25 that includes a combination of recording and reproducing signal processing devices for performing signal input to the magnetic head 23 and reproducing signal output from the magnetic head 23.

By employing such a configuration, a magnetic recording apparatus having a high recording density can be obtained.

Because the recording tracks of the magnetic recording medium 21 are magnetically discontinuous, the conventional technique of reducing the width of the reproduction head to a width narrower than that of the recording head in order to eliminate the adverse effects of magnetized transition regions that exist at the track edges of conventional media need not be employed, and the two heads can be operated at substantially the same width. As a result, an adequate reproduction output and high SNR can be achieved.

Moreover, by forming the reproduction unit of the magnetic head 23 as a GMR head or TMR head, adequate signal intensity can be obtained even in the case of a high recording density, and thus a magnetic recording apparatus having a high recording density can be achieved.

In addition, if the floating height of the magnetic head 23 is set within a range from 0.005 to 0.020 μm, which is lower than conventional floating heights, then the output can be improved, a higher apparatus SNR is obtained, and a high-capacity, high-reliability magnetic recording apparatus can be provided. Furthermore, if a signal processing circuit that employs maximum likelihood decoding is combined, then the recording density can be further improved, and for example, a satisfactory SNR can be achieved for the recording and reproduction of a track density of 100 k-track/inch or higher, a linear recording density of 1,000 kbit/inch or higher, and a recording density per square inch of 100 Gbit or higher.

### EXAMPLES

The present invention will be described in more detail below using a series of examples.

### Example

A glass substrate for the HD was placed inside a vacuum chamber, and the inside of the vacuum chamber was evacuated down to a pressure of not more than 1.0×10⁻⁵ Pa. The glass substrate used here was formed of a crystallized glass containing Li₂Si₂O₅, Al₂O₃—K₂O, Al₂O₃—K₂O, MgO—P₂O₅ and Sb₂O₃—ZnO as components, and had an outer diameter of 65 mm, an inner diameter of 20 mm, and an average surface roughness (Ra) of 2 angstroms.

Using a DC sputtering method, thin films of FeCoB as a soft magnetic layer, Ru as an intermediate layer, and a 70Co—5Cr—15Pt—10SiO₂ alloy as a magnetic layer were laminated in this order on the glass substrate. The thicknesses of each of these layers were 60 nm for the FeCoB soft magnetic layer, 10 nm for the Ru intermediate layer, and 15 nm for the magnetic layer.

A sputtering method was then used to form a mask layer thereon. C was used for the mask layer, and the thickness was 20 nm.

A resist layer was then formed thereon through application using a spin coating method. A novolak-based resin which was an ultraviolet curable resin was used for the resist layer. Further, the thickness of the resist layer was set to 60 nm.

A stamp was pressed against the resist layer at a pressure of 1 MPa (about 8.8 kgfcm²) using a glass stamp having a negative pattern of the magnetic recording pattern. In this state, ultraviolet rays with a wavelength of 250 nm were irradiated for 10 seconds from an upper portion of the glass stamp having an ultraviolet transmittance of 95% or more, so as to cure the resist layer. Thereafter, the stamp was removed from the resist layer to transfer the magnetic recording pattern. The magnetic recording pattern transferred to the resist layer had circular shaped protrusions having a width of 64 nm and a thickness of 65 nm for the resist layer, and circular shaped recesses (the regions corresponding to the negative pattern) having a width of 30 nm and a thickness of about 15 nm for the resist layer. In addition, the angle of the recesses of the resist layer was about 90 degrees with respect to the substrate surface.

Then, the regions corresponding to the negative pattern in the resist layer and the mask layer were removed by dry etching. In terms of the conditions for dry etching, the resist was etched using O₂ gas of 40 sccm, a pressure of 0.3 Pa, a high-frequency plasma power of 300 W, a DC bias of 30 W and an etching time of 10 seconds, whereas the C layer was etched using O₂ gas of 50 sccm, a pressure of 0.6 Pa, a high-frequency plasma power of 500 W, a DC bias of 60 W and an etching time of 30 seconds.

Then, an ion beam was irradiated onto the surface of the regions within the magnetic layer which was not covered by the mask layer. The ion beam was generated using a mixed gas composed of nitrogen gas of 40 sccm, hydrogen gas of 20 sccm and neon of 20 sccm. The amount of ions was set to 5.5×10¹⁵ atoms/cm², the etching rate was set to 0.1 nm/second, the voltage applied to the positive electrode was set to +1,500 V and the voltage applied to the negative electrode was set to −1,500 V, the etching time was set to 84 seconds, and the processing depth of the magnetic layer was set to 8 nm.

Thereafter, the resist layer and the mask layer were removed by dry etching, and a carbon protective film was formed on the surface thereof to a thickness of 4 nm by the CVD method, followed by the application of a lubricant to a thickness of 1.5 nm to produce a magnetic recording medium.

With regard to the magnetic recording medium produced by the method described above, electromagnetic conversion characteristics (SNR and 3T-squash) and the head floating height (glide avalanche) were measured. Here, the term “3T-squash (triple track squash)” refers to the signal degradation in the central track when recording is conducted onto the adjacent tracks on both sides, and the value is derived by the following formula:

(residual signal intensity Vp-p)/(original signal intensity Vp-p)×100 (%).

The closer this value is to 100%, the higher the level of resistance to the recording onto adjacent tracks.

The electromagnetic conversion characteristics were evaluated using a spin stand. In this case, as heads for the evaluation, a perpendicular recording head was used for recording, and a TuMR head was used for reading. A SNR value and 3T-squash were measured when a signal of 750 kFCI was recorded therein.

The produced magnetic recording medium exhibited a SNR of 13.7 dB and a 3T-squash value of 86%, and thus had excellent RW properties, and the head floating properties were also stable. That is, the produced magnetic recording medium exhibited a high level of surface smoothness, and also excellent separating properties due to the non-magnetic portions between tracks in the magnetic layer.

### INDUSTRIAL APPLICABILITY

The present invention can be utilized over a wide range in the manufacturing industry to produce magnetic recording media.

### REFERENCE SIGNS LIST

1: Non-magnetic substrate; 2: Magnetic layer; 3: Mask layer; 4: Resist layer; 5: Stamp; 6: Region corresponding to negative pattern in mask layer; 7: Region within magnetic layer which is not covered by mask layer; 8: Lower layer portion; 10: Ion beam; 11: Region corresponding to negative pattern in resist layer; 12: Region corresponding to negative pattern in magnetic layer; 13: Plasma generation chamber; 14: Electrode; 15: Ion gun; 18: Positive electrode; 19: Negative electrode; 20: Earth electrode; 21: Magnetic recording medium

1. A method of producing a magnetic recording medium having a magnetically separated magnetic recording pattern, comprising, in this order:
a step of forming a magnetic layer on top of a non-magnetic substrate;
a step of forming a mask layer for forming a magnetic recording pattern on top of the magnetic layer; and
a step of irradiating an ion beam onto regions in the magnetic layer which are not covered by the mask layer, removing un upper layer portion of the magnetic layer at that regions, and reforming magnetic properties of a lower layer portion,
wherein two or more types of positive ions having different masses are used for the ion beam, and
an ion gun for forming the ion beam has a positive electrode that forces out positive ions from an ion source towards a substrate side, and a negative electrode that accelerates the positive ions towards the substrate side.

2. The method of producing a magnetic recording medium according to claim 1, wherein two or more types of the positive ions having different masses are ions containing nitrogen and hydrogen or neon.

3. The method of producing a magnetic recording medium according to claim 1, wherein the ion gun includes an earth electrode that stabilizes energy distribution of the positive ions from the ion source, and electrodes of the ion gun, i.e., the positive electrode, the negative electrode and the earth electrode are provided in this order from the ion source to the substrate side.

4. The method of producing a magnetic recording medium according to claim 1, wherein a voltage applied to the positive electrode is within a range from +500 V to +1,500 V, and a voltage applied to the negative electrode is within a range from −2,000 V to −1,000 V.

5. The method of producing a magnetic recording medium according to claim 1, wherein electrodes of the ion gun are mesh electrodes.

6. A magnetic recording and reproducing apparatus comprising:
a magnetic recording medium obtained by the method described in claim 1; and
a magnetic head for recording data in or reproducing data from the magnetic recording medium.
